(19) United States
(12) Patent Application Publication
(10) Pub. No.: US 2011/0161447 A1
(43) Pub. Date: Jun. 30, 2011

(54) METHOD AND SYSTEM FOR RESPONDING TO MESSAGES

(75) Inventor: JUI CHING LIN, HSINCHU COUNTY (TW)

(73) Assignee: RALINK TECHNOLOGY CORPORATION, HSINCHU COUNTY (TW)

(21) Appl. No.: 12/959,860

(22) Filed: Dec. 3, 2010

(30) Foreign Application Priority Data
Dec. 29, 2009 (TW) 098145437

(51) Int. Cl. G06F 15/16

(52) U.S. Cl. 709/206

(57) ABSTRACT

A method for responding to messages comprises the steps of: establishing a first database; establishing a second database; forwarding content of the first database to a first proxy device; forwarding content of the second database to a second proxy device; utilizing the first proxy device to respond to at least one first real message; and utilizing the second proxy device to respond to at least one second real message.

### BACKGROUND OF THE INVENTION

1. Field of the Invention

The present invention relates to a method and system for responding to messages.

2. Description of the Related Art

Consumer Electronics Control (CEC) conducts a single-wire bidirectional transmission, which is used to perform control and detection between audio/video devices complying with High Definition Multimedia Interface (HDMI) standard, so as to reduce the number of remote controllers and the amount of button-pressing by users.

Some CEC characteristics described in HDMI version 1.3 are as follows: one-touch play, which allows the user to press one key to play the device or turn the device into an active source; system standby, which allows the user to randomly switch any one or all devices to enter standby mode; one-touch record, which allows the user to record anything he/she sees; deck control, which utilizes one device to control another device to play or rewind; tuner control, which allows one device to control the tuner of another device; device menu control, which utilizes a user interface on a display device to control another device; remote control pass through, which forwards command instructions of the remote controller to another device through HDMI interface to directly control that device.

HDMI version 1.3 specifies that any device must respond to incoming messages within 0.35 ms. However, in a wireless HDMI structure, the device may not respond in such a timely manner due to poor wireless communication quality.

### SUMMARY OF THE INVENTION

The present invention proposes a method and system for responding to messages. A first proxy device obtains training responding messages by forwarding a CEC training message to an associated first electronic controller. The CEC training message includes all responding messages that should be responded to by the first electronic controller. The first proxy device establishes a first database in accordance with an obtained training responding message and a logical position of the first electronic controller. Thereafter, the content of the first database is forwarded to the second proxy device. Similarly, the second proxy device performs the same steps to establish the second database, and forwards the content of the second database to the first proxy device. By means of establishing databases in advance and exchanging the content thereof, the requirement of timely response complying with HDMI standard can be achieved.

The message responding method in accordance with one embodiment of the present invention comprises the steps of: establishing a first database; establishing a second database; forwarding the content of the second database to a first proxy device; forwarding the content of the first database to a second proxy device; utilizing the first proxy device to respond to a first real message in accordance with the content of the second database; and utilizing the second proxy device to respond to a second real message in accordance with the content of the first database.

The message responding system in accordance with one embodiment of the present invention comprises a first proxy device and a second proxy device. The first proxy device is configured to forward at least one first training message to a first electronic controller, and is configured to establish a first database in accordance with logical positions of the first electronic controller and at least one first training responding message or responding to at least one first real message in accordance with the content of a second database. The second proxy device is configured to forward at least one second training message to a second electronic controller, and is configured to establish a second database in accordance with logical positions of the second electronic controller and at least one second training responding message or responding to at least one second real message in accordance with the content of a first database.

### BRIEF DESCRIPTION OF THE DRAWINGS

The invention will be described according to the appended drawings in which:

FIG. 1 shows a message exchange system in accordance with one embodiment of the present invention;

FIG. 2 shows a flow chart of message responding method in accordance with one embodiment of the present invention; and

FIG. 3 shows sub-steps of step 202 in detail.

### PREFERRED EMBODIMENT OF THE PRESENT INVENTION

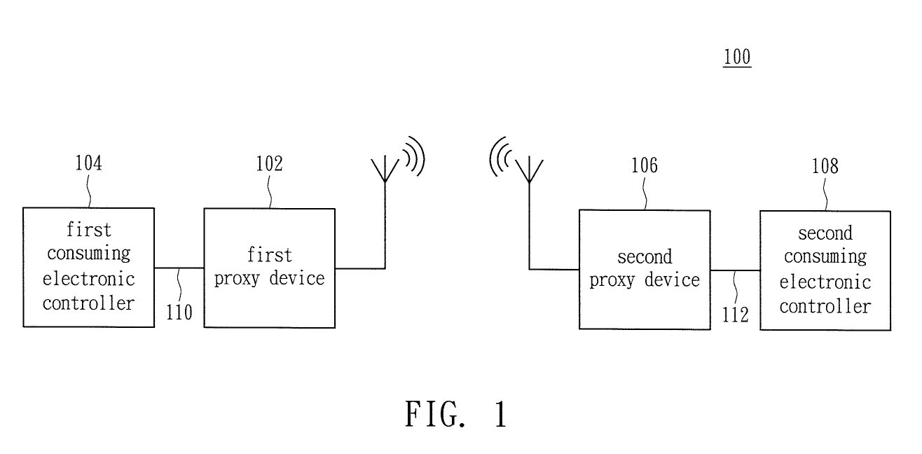

FIG. 1 shows a message exchange system in accordance with one embodiment of the present invention. The message exchange system 100 includes a first proxy device 102, a first electronic controller 104, a second proxy device 106, a second electronic controller 108, a first wireless High Definition Multimedia Interface (HDMI) electronic controlling cable 110 and a second wireless HDMI electronic controlling cable 112. The first proxy device 102 and the first electronic controller 104 are connected through the first wireless HDMI electronic controlling cable 110, while the second proxy device 106 and the second electronic controller 108 are connected through the second wireless HDMI electronic controlling cable 112.

In accordance with one embodiment of the present invention, the first proxy device 102 and the second proxy device 106 may be wireless HDMI servers. The first electronic controller 104 may be an audio/video player. The second electronic controller 108 may be an LCD TV. The first proxy device 102 is used to forward a CEC training message to the first electronic controller 104, and to establish a first database in accordance with the logical position of the first electronic controller 104 and the training responding messages sent by the first electronic controller in response to the CEC training message. The CEC training message includes all possible messages that should be responded to by the first electronic controller 104. After the first database is established, the first proxy device 102 forwards the content of the first database by wireless signal to the second proxy device 106.

The second proxy device 106 forwards a CEC training message to the second electronic controller 108, and establishes a second database in accordance with the logical position of the second electronic controller 108 and training responding messages. After the second database is established, the second proxy device 106 forwards the content of the second database by wireless signal to the first proxy device 102. Thereafter, if the first electronic controller 104 issues a real message, then the first proxy device 102 responds to the real messages issued by the first electronic controller 104 in accordance with the content of the second database established by the second proxy device 106. Similarly, if the second electronic controller 108 issues a real message, then the second proxy device 106 responds to the real messages issued by the second electronic controller 108 in accordance with the content of the first database established by the first proxy device 102.

In addition, the first proxy device 102 forwards real messages issued by the second electronic controller 108 to the first electronic controller 104, and verifies the content of the first database in accordance with responding messages issued by the first electronic controller 104 in response to the real messages issued by the second electronic controller 108. If there is any discrepancy, the content of the first database is updated and forwarded to the second proxy device 106. Similarly, the second proxy device 106 further forwards real messages issued by the first electronic controller 104 to the second electronic controller 108, and verifies the content of the second database in accordance with responding messages issued by the second electronic controller 108 in response to the real messages issued by the first electronic controller 104. If there is any discrepancy, the content of the second database is updated and forwarded to the first proxy device 102.

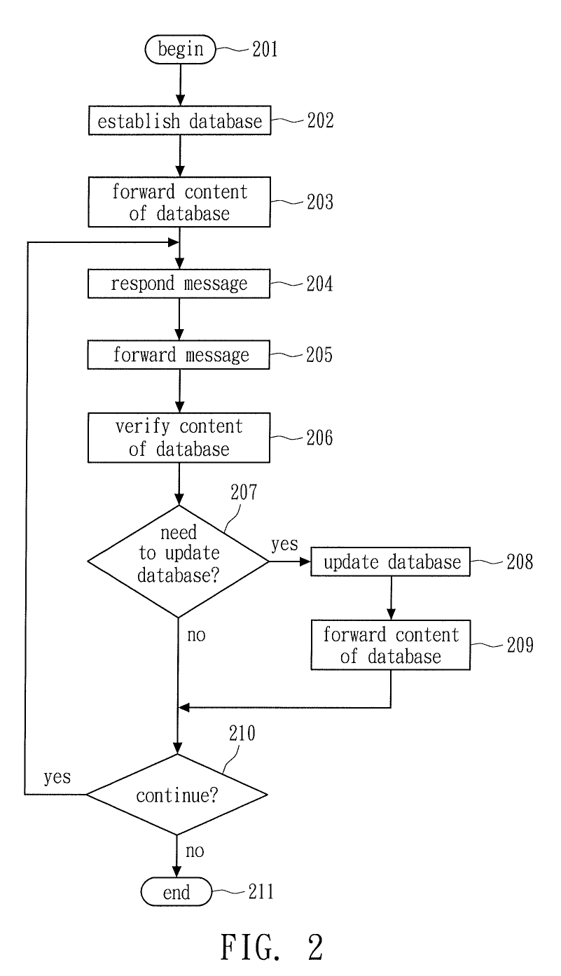

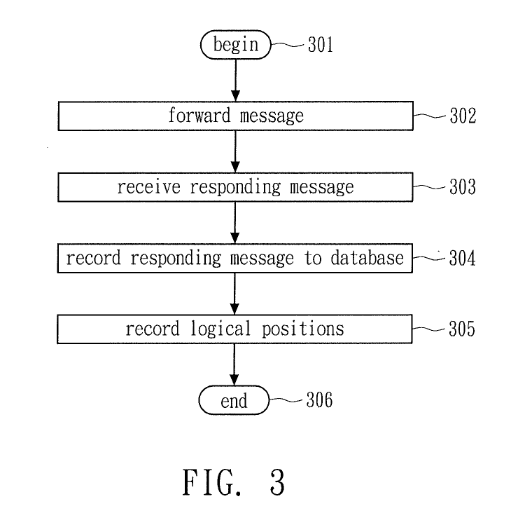

FIG. 2 shows a flow chart of a message responding method in accordance with one embodiment of the present invention. Please refer to FIGS. 1 and 2. In step 201, the process flow begins. In step 202, the first proxy device 102 and the second proxy device 106 separately establish first and second databases. FIG. 3 shows sub-steps of step 202 in detail. In step 302, the first proxy device 102 forwards CEC training messages to the first electronic controller 104. The CEC training messages include all messages that should be responded to by the first electronic controller 104. In step 303, training responding messages issued by the first electronic controller 104 in response to the CEC training messages are received. In step 304, the training responding messages are recorded in the first database. In step 305, the logical position of the first electronic controller 104 is recorded in the first database. Similarly, the second proxy device 106 performs the steps 301 to 305 to establish the second database. In step 203, after the first and second databases are established, the first proxy device 102 forwards the content of the first database by wireless signal to the second proxy device 106, and the second proxy device 106 forwards the content of the second database by wireless signal to the first proxy device 102. In step 204, the first proxy device 102 responds to the real messages issued by the first electronic controller 104 in accordance with the content of the second database. Similarly, the second proxy device 106 responds to the real messages issued by the second electronic controller 108 in accordance with the content of the first database. In step 205, the first proxy device 102 forwards the real messages issued by the first electronic controller 104 to the second electronic controller 108 through the second proxy device 106, and the second proxy device 106 forwards the real messages issued by the second electronic controller 108 to the first electronic controller 104 through the first proxy device 102. In step 206, the first proxy device 102 verifies the content of the first database in accordance with responding messages issued by the first electronic controller 104 in response to the real messages issued by the second electronic controller 108, and the second proxy device 106 verifies the content of the second database in accordance with responding messages issued by the second electronic controller 108 in response to the real messages issued by the first electronic controller 104. In step 207, it is determined whether to update the first and second databases. In step 208, if the content of the second database needs to be updated, the second database is updated. In step 209, the second proxy device 106 forwards the updated second database to the first proxy device 102 so that the first proxy device 102 can respond to real messages issued by the first electronic controller 104 in accordance with the updated second database. In step 210, it is determined whether to continue the process flow. If negative, the process ends in step 211; otherwise, steps 204 to 207 are repeated.

The above-described embodiments of the present invention are intended to be illustrative only. Numerous alternative embodiments may be devised by persons skilled in the art without departing from the scope of the following claims.

What is claimed is:

1. A message responding method, comprising the steps of:
establishing a first database;
establishing a second database;
forwarding the content of the second database to a first proxy device;
forwarding the content of the first database to a second proxy device;
utilizing the first proxy device to respond to a first real message in accordance with the content of the second database; and
utilizing the second proxy device to respond to a second real message in accordance with the content of the first database.

2. The method of claim 1, further comprising:
utilizing the second proxy device to forward the second real message through the first proxy device to a first electronic controller; and
utilizing the first proxy device to forward the first real message through the second proxy device to a second electronic controller.

3. The method of claim 2, wherein the first and second real messages are issued by the first electronic controller and the second electronic controller, respectively.

4. The method of claim 2, wherein the step of establishing the first database comprises:
forwarding a first training message to the first electronic controller;
receiving a first training responding message issued by the first electronic controller in response to the first training message; and
recording the first training responding message to the first database.

5. The method of claim 4, wherein the step of establishing the first database further comprises the step of verifying the content of the first database in accordance with a second real responding message issued by the first electronic controller in response to the second real message.

6. The method of claim 4, wherein the step of establishing the first database further comprises the step of recording logical positions of the first electronic controller to the first database.

7. The method of claim 2, wherein the step of establishing the second database comprises:
forwarding a second training message to the second electronic controller;
receiving a second training responding message issued by the second electronic controller in response to the second training message; and
recording the second training responding message to the second database.

8. The method of claim 7, wherein the step of establishing the second database further comprises the step of verifying the content of the second database in accordance with a first real responding message issued by the second electronic controller in response to the first real message.

9. The method of claim 7, wherein the step of establishing the second database further comprises the step of recording logical positions of the second electronic controller to the second database.

10. The method of claim 1, wherein the first proxy device forwards the content of the first database through wireless signal to the second proxy device.

11. The method of claim 1, wherein the second proxy device forwards the content of the second database through wireless signal to the first proxy device.

12. The method of claim 2, wherein the first proxy device is connected to the first electronic controller through a first high definition multimedia interface (HDMI) electronic control cable.

13. The method of claim 2, wherein the second proxy device is connected to the second electronic controller through a second HDMI electronic control cable.

14. A message responding system, comprising:
a first proxy device configured to forward at least one first training message to a first electronic controller, and configured to establish a first database in accordance with logical positions of the first electronic controller and at least one first training responding message or responding to at least one first real message in accordance with the content of a second database; and
a second proxy device configured to forward at least one second training message to a second electronic controller, and configured to establish a second database in accordance with logical positions of the second electronic controller and at least one second training responding message or responding to at least one second real message in accordance with the content of the first database.

15. The system of claim 14, wherein the first and second real messages are issued by the first and second electronic controllers.

16. The system of claim 14, wherein the first proxy device forwards the content of the first database through wireless signal to the second proxy device.

17. The system of claim 14, wherein the second proxy device forwards the content of the second database through wireless signal to the first proxy device.

18. The system of claim 14, wherein the first proxy device forwards the second real message to the first electronic controller, or verifies the content of the first database in accordance with a second real responding message issued by the first electronic controller in response to the second real message.

19. The system of claim 14, wherein the second proxy device to forwards the first real message to the second electronic controller, or verifies the content of the second database in accordance with a first real responding message issued by the second electronic controller in response to the first real message.

20. The system of claim 14, wherein the first proxy device is connected to the first electronic controller through a first HDMI electronic control cable, and the second proxy device is connected to the second electronic controller through a second HDMI electronic control cable.
